(19) United States
(12) Patent Application Publication
(10) Pub. No.: US 2004/0205734 A1
(43) Pub. Date: Oct. 14, 2004

(54) Dynamic notification of non java services using jini (TM)

(76) Inventors: Krishnamurthy Srinivasan, Chandler, AZ (US); Edala R. Narasimha, Tempe, AZ (US)

Correspondence Address: FISH & RICHARDSON, PC, 12390 EL CAMINO REAL, SAN DIEGO, CA, 92130-2081, US

(21) Appl. No.: 09/734,314

(22) Filed: Nov. 30, 2000

(51) Int. Cl. G06F 9/45

(52) U.S. Cl. 717/140

(57) ABSTRACT

A Jini converting system, which enables COM clients to request Java services from Jini. The requests are translated to a form that can be read by Jini. Applications are returned in a way that can be executed on the COM client.

### BACKGROUND

Jini (™) is an established service which allows application services to announce their availability dynamically. Users of services can dynamically find an application service using Jini. Examples can include services providing freight rates, stock quotes, price inventory levels for products of modules (e.g., calculators) for applications. Jini (™) operates by requiring a client to register an interest in using one of these services. Jini (™) also provides proxy code to the client allowing the client to communicate with the services. In this way, Jini (™) acts as a broker between the client and the existing services.

Jini (™) has been configured in a way such that it can only be used by client applications written in Java. Many non-Java clients (“Legacy” clients), however exist. These existing clients cannot operate through Jini (™).

### BRIEF DESCRIPTION OF THE DRAWINGS

These and other aspects will now be described in detail with reference to the accompanying drawings, wherein:

FIG. 1 shows a block diagram of a request for Jini services; and

FIG. 2 shows a flowchart of operation.

### DETAILED DESCRIPTION

The description given herein assumes a Jini (™) service with a component object model (“COM”) client. However, it should be understood that this same technique could be used for any Java Brokering service that interfaces with a non Java client.

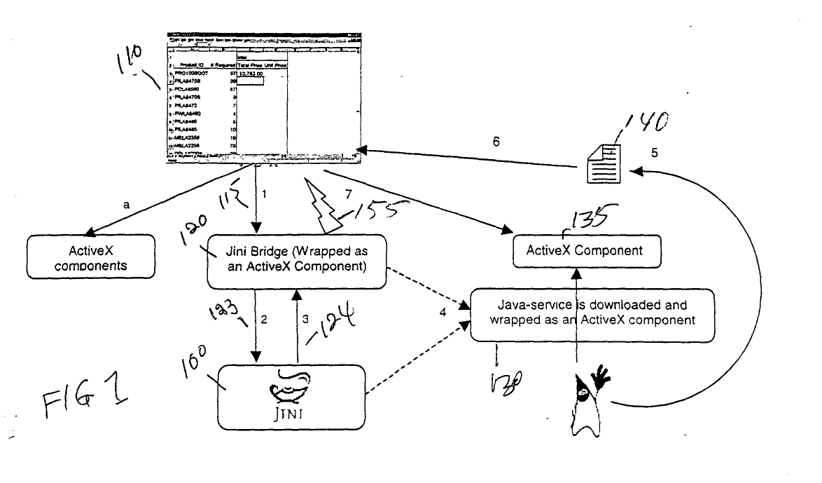

A COM container application, such as Excel (™) is shown as the client to receive services deployed through Jini (™). FIG. 1 shows the basic operation of an Excel object 110 attempting dynamic discovery of services such as a calculator. The COM client is looking for a calculator through the Jini (™) brokering service. This looking requires two functions to be carried out. At 200, the system begins looking for service by representing interest in the service to the Jini (™) broker 100. The interest can be expressed by specifying GUIDs (globally unique identifiers), interface classes, or search attributes as keywords on behalf of the client. The application 110 provides this information 115 request to Jini (™) bridge 120. The Jini (™) bridge 120 is wrapped as an activeX component and translates the information either synchronously or asynchronously, into a Jini (™) request 123 at 210. The request is transmitted to the Jini broker 100 at 220. Jini (™) 100 and then returns matches/answers 124 in the usual way at 230. This includes service matches representing the closest elements to the requested parts. Java objects are returned as the services. In this embodiment, the Java objects can be representative of Java services, or of non-Java services that are wrapped to look like Java services.

COM applications such as 110 cannot directly call for services from these Java objects. The bridge 120 therefore serializes the object code from Jini (™) and couples the serialized object code coupled to the JavaBean Active X bridge 130. This code is wrapped as an Active X Java service shown as 135. The active x components 135 can in fact be accessed by the COM application 110.

The Java-Active X bridge is a Java service component which uses architecture's introspection such as Java reflection and COM's I type library to generate using the “reflection” (™) service. It generates plumbing code which acts as the bridge code between the COM application, Excel, and the Java proxy.

Each of the returned Java services, therefore, is wrapped as an activeX component. Hence, the Excel COM application 110 has access to any of these activeX components.

The bridge 120 also identifies methods and functionality in the wrapped Java service components using “reflection”. The bridge 120 generates plumbing code between the COM application (here Excel) and the Java service which is now available as a wrapped local Active X component. The plumbing code is shown as 140 in FIG. 1. This plumbing code uses code that can be recognized by the COM application; here code in Visual Basic for applications (“VBA”) format.

The plumbing code 140 as the VBa object is inserted as a module sheet into the Excel workbook, shown as 110. At that point, the functions defined in the code become available as user functions.

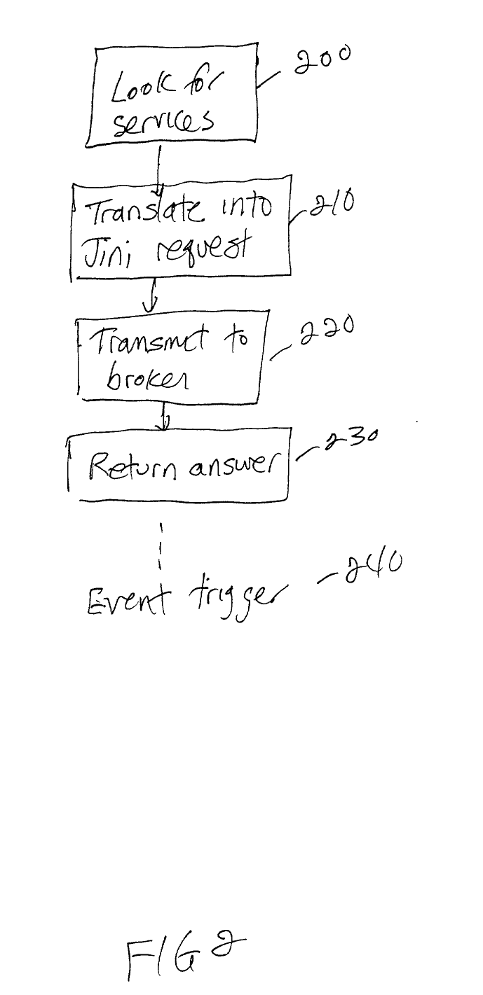

An event trigger 155 forms an indicator that a new service from Jini (™) is available, shown as 240 in FIG. 2. This is sent to the container application 110 to provide an indication that the new functionality is available.

Although only a few embodiments have been disclosed in detail above, other modifications are possible.

What is claimed is:

1. A method, comprising:
from that a first, non Java client, requesting specified services from a Java broker;
wrapping a Java service obtained responsive to said requesting as a wrapped Java component, in a way such that said Java service can be processed as a non Java component; and
converting said wrapped Java service into a form which can be embedded in a non Java client.

2. A method as in claim 1, wherein said form is a form of a Visual Basic application.

3. A method as in claim 1 to wherein said non Java client is a COM client.

4. A method as in claim 3 wherein said non Java client is a client which enables certain mathematical functions to be carried out, and said Java component is a mathematical operation component.

5. A method as in claim 4 wherein said mathematical operation is embedded into said non-Java client in a way which allows mathematical functions to be carried out within said client by said wrapped Java components.

6. A method as in claim 5, wherein said non Java client is a spreadsheet client.

7. A method as in claim 1, wherein said Java service is wrapped as an activeX service.

8. A method as in claim 1, further comprising maintaining a list of Java services which are available at said non-Java client.

9. A method as in claim 1, further comprising monitoring for new services, and sending a trigger indicating that a new service is available.

10. A method comprising:
requesting, from a COM client, a service having specified characteristics;
dynamically discovering a service with said characteristics on a non COM client, responsive to said requesting; and
returning said service from said non COM client to said COM client in a way that allows said service to be executed on the COM client.

11. A method as in claim 10, wherein said service is a non COM application that is returned as a wrapped application, said wrapped application having code that can be executed on the COM client to execute said non COM type application.

12. A method as in claim 11, wherein said non COM application is wrapped as an ActiveX component.

13. A method as in claim 11, wherein the non COM application is a Java application.

14. A method as in claim 10, wherein the non COM client is a Jini® client which can discover Java services.

15. A method as in claim 10 wherein said returning comprises serializing object code from the non COM service and wrapping the serialized code as an ActiveX component.

16. A method as in claim 15, further comprising producing Visual Basic code which can be embedded into the COM application.

17. An apparatus comprising a machine-readable storage medium having executable instructions for enabling the machine to:
at a COM client, determine a request for a specified service type;
form a request having a non COM format; and
couple said request to a broker for non COM services.

18. An apparatus as in claim 17, wherein said non COM request is a Java request.

19. An apparatus as in claim 17, wherein said broker is a Jini broker.

20. A computer as in claim 17 further comprising returning a non COM service responsive to said request, said non COM service being packaged in a way that allows reading by a COM service.

21. A computer as in claim 20 wherein said package comprises an ActiveX package.

22. A system, comprising:
a first, non Java client, of a type that can use specified services; and
a request forming bridge, requesting specified services from a Java broker by translating a request for services to a Java complaint format, and sending said request to a remote Java broker.

23. A system as in claim 22, wherein said Java complaint format is a format with Java code that translates a request from non-Java code.

24. A system as in claim 22, further comprising a Java broker, storing information about a plurality of services, and selecting services to return based on said request.

25. A system as in claim 24, further comprising a Java service wrapping bridge, receiving a Java service responsive to said request, and forming code that allows said service to be interpreted by said non-Java client.

26. A system as in claim 25, wherein said non-Java client is a COM client.
